(19) United States
(12) Patent Application Publication
(10) Pub. No.: US 2018/0285292 A1
(43) Pub. Date: Oct. 4, 2018

(54) SYSTEM AND METHOD OF SENDING DATA VIA ADDITIONAL SECONDARY DATA LINES ON A BUS

(71) Applicant: QUALCOMM Incorporated, San Diego, CA (US)

(72) Inventors: Lior Amarilio, Yokneam (IL); Ramzi Elkhater, San Diego, CA (US); Sharon Graif, Zichron Yaakov (IL); Magesh Hariharan, San Diego, CA (US); Ghanashyam Prabhu, Bangalore (IN); Michael Shettel, Broomfield, CO (US)

(21) Appl. No.: 15/870,436

(22) Filed: Jan. 12, 2018

(30) Foreign Application Priority Data
Mar. 28, 2017 (IN) 201741010931

(51) Int. Cl. G06F 13/24; G06F 13/42; G06F 1/14; G06F 1/32

(52) U.S. Cl. CPC G06F 13/24; G06F 1/32; G06F 1/14; G06F 13/4282

(57) ABSTRACT

A serial low-power inter-chip media bus (SLIMbus) communications link is deployed in apparatus having multiple integrated circuit (IC) devices. Systems, methods and apparatus are described that can improve the operation of SLIMbus communications links. A method includes determining that an interrupt asserted within a first device coupled to a SLIMbus is directed to a second device coupled to the SLIMbus and generating an in-band interrupt (IBI) message identifying the first device as an interrupt source, the second device as an interrupt target, and including information identifying a type and a status associated with the interrupt, and transmitting the IBI message to the second device over the SLIMbus.

### PRIORITY APPLICATION

The present application claims priority to Indian Provisional Patent Application Serial No. 201741010931, filed Mar. 28, 2017 and entitled “SYSTEM AND METHOD OF SENDING DATA VIA ADDITIONAL SECONDARY DATA LINES ON A BUS,” which is incorporated herein by reference in its entirety.

### BACKGROUND

### Field

The present disclosure relates generally to data communications interfaces, and more particularly, to data communications links provided between multiple devices.

### Background

Manufacturers of mobile devices, such as cellular phones, may obtain components of the mobile devices from various sources, including different manufacturers. For example, an application processor (AP) in a cellular phone may be obtained from a first manufacturer, while the display for the cellular phone may be obtained from a second manufacturer. The AP and a display or other device may be interconnected using a standards-based or proprietary physical interface.

In one example, the serial low-power inter-chip media bus (SLIMbus) standard is a communication bus standard that is well-suited for use in portable computing devices such as mobile phones. In accordance with the SLIMbus standard, components may be connected by a single SLIMbus data line and a single clock line. However, new generations of devices attached to a SLIMbus require ever-increasing bandwidth and throughput for applications that process and communicate audio and video data, while reducing pin counts.

Accordingly, there is a need to efficiently increase communication bandwidths available between components of mobile devices and other apparatus.

### SUMMARY

Embodiments disclosed herein provide systems, methods, and apparatus that can improve the operation of serial low-power inter-chip media bus (SLIMbus) communications links. The communications link may be deployed in apparatus such as a mobile terminal having multiple integrated circuit (IC) devices.

Certain aspects of this disclosure define an in-band interrupt (IBI) signaling process that includes a race-proof interrupt clear sequence to avoid these hazards. IBI signals may include information identifying a type and a status associated with an originating interrupt condition. An IBI implementation can simplify software operation and responsibilities and provide higher bus utilization while enabling full coexistence of other use-cases, while providing pin reductions.

In various aspects of the disclosure, a data communications method includes determining that an interrupt asserted within a first device coupled to a SLIMbus is directed to a second device coupled to the SLIMbus, generating an IBI message identifying the first device as an interrupt source, the second device as an interrupt target, and including information identifying a type and a status associated with the interrupt, and transmitting the IBI message to the second device over the SLIMbus.

In certain aspects, the method includes determining that the SLIMbus is in a clock-stop or a powered-down mode of operation when the interrupt is determined to be asserted, and toggling a data line of the SLIMbus prior to transmitting the IBI message to the second device. The method may include determining that a clock signal of the SLIMbus is active after toggling the data line of the SLIMbus and prior to transmitting the IBI message to the second device. The method may include storing the status associated with the interrupt in a register, receiving an interrupt acknowledgement from the second device, and clearing the status associated with the interrupt in the register in response to the interrupt acknowledgement received from the second device.

In some aspects, the first device is a coder/decoder circuit. The second device may include a digital signal processor (DSP) or an application processor (AP).

In various aspects of the disclosure, a data communications method includes receiving at a master device coupled to a SLIMbus, an IBI message identifying a first device as an interrupt target and a second device as an interrupt source, the IBI message including information identifying a type and a status associated with an interrupt, and asserting an interrupt signal at the first device. The first device may be one of a plurality of destinations for interrupts received in IBI messages.

In certain aspects, the SLIMbus is in a clock-stop or a powered-down mode of operation prior to receipt of the IBI message, and the method may include detecting that a data line of the SLIMbus has been toggled prior to receipt of the IBI message, and waking up a framer of the master device after detecting that the data line of the SLIMbus has been toggled. The method may include waking up a SLIMbus interface circuit of the master device after detecting that the data line of the SLIMbus has been toggled. The method may include actively driving a clock line of the SLIMbus after detecting that the data line of the SLIMbus has been toggled.

In some aspects, the method includes storing the status associated with the interrupt in a register, receiving an interrupt acknowledgement from the second device, and clearing the status associated with the interrupt in the register in response to the interrupt acknowledgement received from the second device.

In some aspects, the first device may include a DSP or an AP. The second device may include a coder/decoder circuit.

In various aspects of the disclosure, a system includes a serial bus having a clock line and at least one data line, a first device coupled to the serial bus through a bus master interface, and a second device coupled to the serial bus through a bus slave interface. The first device may include a plurality of processors and a message parser. The second device may include an interrupt source and a message generator. The message generator may be configured to determine that an interrupt asserted by a first interrupt source is directed to a first processor on the first device and generate an IBI message identifying the interrupt source and the first processor as an interrupt target. The IBI message may include information identifying a type of the interrupt and a status associated with the interrupt. The bus slave interface may be configured to transmit the IBI message to the second device over the serial bus. The message parser may be configured to receive the IBI message from the bus master interface, and assert the interrupt at the first device based on a content of the IBI message.

In one aspect, the serial bus is operated in accordance with a time-division transmission protocol.

In some aspects, the second device includes a circuit configured to determine whether the serial bus is operating in a low-power mode and cause a change in a signaling state of the serial bus operable to wake up the serial bus when the serial bus is operating in the low-power mode, before the IBI message is transmitted to the second device over the serial bus. The clock line may be quiescent during the low-power mode. The change in the signaling state of the serial bus may include a toggling of the at least one data line. The first device may include a power management circuit configured to detect the change in the signaling state of the serial bus and cause the bus master interface to actively drive at least the clock line.

In one aspect, the serial bus comprises a SLIMbus.

In certain aspects, the first device and the second device each include interrupt status registers configured to maintain a local interrupt status based on a series of IBI messages generated by the message generator. The interrupt status registers of the first device and the second device are cleared responsive to transmission and reception of the series of IBI messages.

### BRIEF DESCRIPTION OF THE DRAWINGS

FIG. 1 depicts an apparatus employing a data link between integrated circuit (IC) devices that selectively operates according to one of a plurality of available standards.

FIG. 2 illustrates a simplified system architecture for an apparatus employing a data link between IC devices.

FIG. 3 illustrates a serial low-power inter-chip media bus (SLIMbus) communications link provided between SLIMbus components.

FIG. 4 illustrates a device adapted to communicate over a SLIMbus communications link.

FIG. 5 illustrates a system that includes a modem and a Codec that communicate through a SLIMbus interface that includes interrupt lines.

FIG. 6 illustrates a system that includes a modem and a Codec that communicate through a SLIMbus interface where physical interrupt lines can be eliminated in accordance with certain aspects disclosed herein.

FIG. 7 illustrates a SLIMbus Information Map.

FIG. 8 illustrates a system in which a Codec is configured to combine wake-up signaling and interrupts in accordance with certain aspects disclosed herein.

FIG. 9 illustrates a system in which a modem is configured to support in-band interrupt (IBI) messages according to certain aspects disclosed herein.

FIG. 10 is a timing diagram illustrating a wake-up sequence employed in accordance with certain aspects disclosed herein.

FIG. 11 is a flow diagram illustrating the operation of a system that employs IBI messages in accordance with certain aspects disclosed herein.

FIG. 12 is a block diagram illustrating an example of an apparatus employing a processing system that may be adapted according to certain aspects disclosed herein.

FIG. 13 is a flowchart illustrating an example of IBI handling at a slave device in accordance with certain aspects disclosed herein.

FIG. 14 is a flowchart illustrating an example of IBI handling at a master device in accordance with certain aspects disclosed herein.

FIG. 15 is a flowchart illustrating a method for data communications on a SLIMbus slave according to certain aspects disclosed herein.

FIG. 16 illustrates an example of an apparatus operating as a SLIMbus slave in accordance with certain aspects disclosed herein.

FIG. 17 is a flowchart illustrating a method for data communications on a SLIMbus master according to certain aspects disclosed herein.

FIG. 18 illustrates an example of an apparatus operating as a SLIMbus master in accordance with certain aspects disclosed herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system,” and the like are intended to include a computer-related entity, such as, but not limited to, hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer-readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Certain aspects of the invention may be applicable to communications links deployed between electronic devices that may include subcomponents of an apparatus such as a telephone, a mobile computing device, a wearable computing device, a media player, a gaming device, an appliance, automobile electronics, avionics systems, etc.

Overview

In-band interrupt (IBI) signaling on an audio peripheral interface, such as a serial low-power inter-chip media bus (SLIMbus), can replace physical interrupts by transporting interrupt status information on SLIMbus control space bandwidth. Such IBI designs can be vulnerable to hazards such as race conditions that can result in repeated interrupts or missed interrupts. Certain aspects of this disclosure define an IBI signaling process that includes a race-proof interrupt clear sequence to avoid these hazards. IBI signals may include information identifying a type and a status associated with an originating interrupt condition. An IBI implementation can simplify software operation and responsibilities and provide higher bus utilization while enabling full coexistence of other use-cases, while providing pin reductions. As used herein, status information may relate to a type of event such as overheat, underflow, overflow, button press, volume up/down, mute, pause, play, plug-in or unplug (e.g., of a headset) or the like.

In an exemplary aspect, IBI Logic in a slave monitors the interrupt status information of a codec, and may generate and initiate transmission of a REPORT_INFORMATION (RPT_INFO) message on SLIMbus control space bandwidth. RPT_INFO may encapsulate interrupt status information, a slave device address, and a host device address. RPT_INFO may target part of User-Information-Elements space with each interrupt corresponding to an address space of 16-bytes. IBI messages can fully replace hardware interrupt pins, and may provide support for waking up a processor (such as a digital signal processor (DSP)) when in a low-power state. IBI messages may be transmitted with full interrupt status information.

A SLIMbus master provided in a modem may be adapted to include a software configurable message parser adapted to monitor interrupts and provide interrupt steering to map or direct received interrupts to one or more processors or other execution environments. Software masking and clearing of local interrupt status bits may be supported within an adapted SLIMbus master.

A SLIMbus slave in a codec may be adapted to support a configurable number of interrupts, interrupt status width (1-16 bytes), masking of each interrupt signal, and configurable destinations for each interrupt.

When a SLIMbus interface is at clock pause mode (low-power operating state), the slave device can wake up the Framer to restart the clock signal by asserting a ‘bus-toggle’ on the DATA line. The active Framer detects the toggle and resumes the clock so the slave device can transmit the IBI.

In comparison to dedicated interrupt lines, IBI messages configured according to certain aspects disclosed herein can reduce interrupt status information access time by approximately one millisecond (1 ms) when the interrupt status information is locally available in the host. According to certain aspects disclosed herein, the sequence of clearing local copies of interrupt status information in the devices ensure removal of hazards including race conditions. IBI messages configured according to certain aspects disclosed herein can remove the need for dedicated interrupt lines saving general purpose input output (GPIO) pins, thereby improving product value/cost per unit die area.

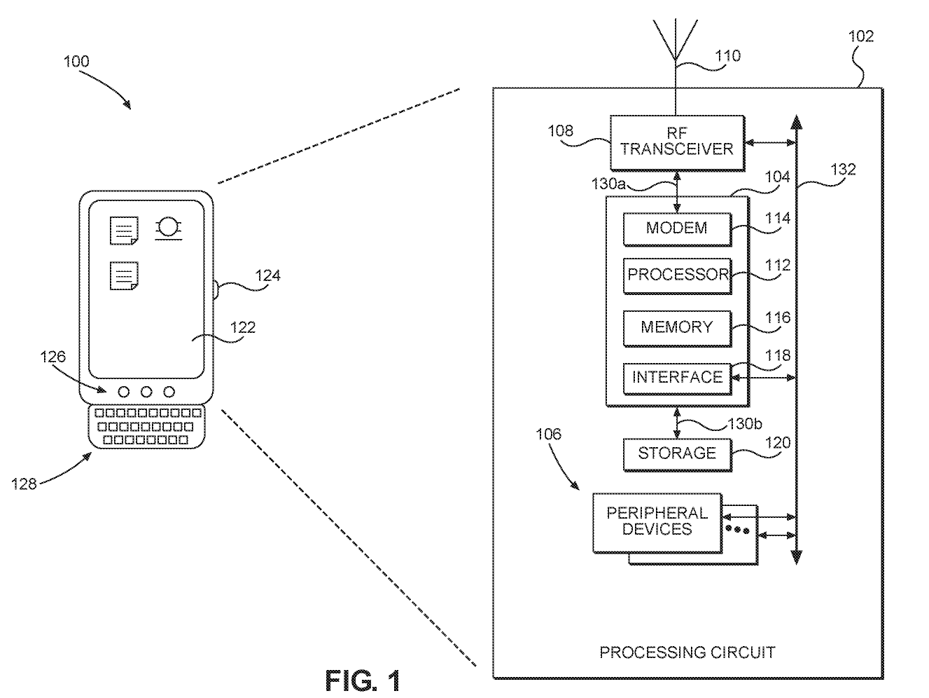

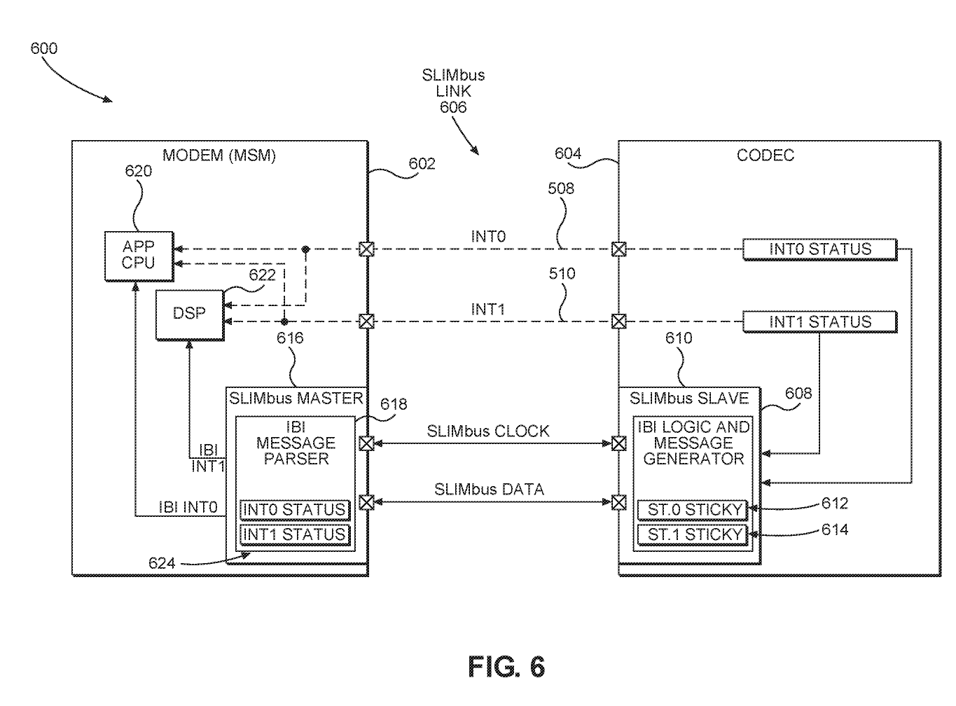

Before addressing exemplary aspects of the present disclosure, an overview of computing devices that may utilize the present disclosure is provided as well as a computing device using a SLIMbus communication bus as well as a computing device using dedicated lines for interrupt signaling with reference to FIGS. 1-5. The discussion of exemplary aspects of the present disclosure begins below with reference to FIG. 6.

Example of an Apparatus Including a Serial Bus

FIG. 1 illustrates an example of an apparatus 100 that may employ a data communications bus. The apparatus 100 may include a processing circuit 102 that may be a system on a chip (SoC) having multiple circuits or devices 104, 106, and/or 108, which may be implemented in one or more application-specific integrated circuits (ASICs) or in an SoC. In one example, the apparatus 100 may be a communications device, and the processing circuit 102 may include a processing device provided in an ASIC 104, one or more peripheral devices 106, and a transceiver 108 that enables the apparatus 100 to communicate through an antenna 110 with a radio access network, a core access network, the Internet, and/or another network.

The ASIC 104 may have one or more processors 112, one or more modems 114, an on-board memory 116, a bus interface circuit 118, and/or other logic circuits or functions. In an exemplary aspect, the ASIC 104 is a multi-core processor. The processing circuit 102 may be controlled by an operating system that may provide an application programming interface (API) layer that enables the one or more processors 112 to execute software modules residing in the on-board memory 116 or other processor-readable storage 120 provided on the processing circuit 102. The software modules may include instructions and data stored in the on-board memory 116 or the processor-readable storage 120. The ASIC 104 may access its on-board memory 116, the processor-readable storage 120, and/or storage external to the processing circuit 102. The on-board memory 116 and the processor-readable storage 120 may include read-only memory (ROM) or random access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 110, a display 122, operator controls, such as switches or buttons 124 and 126, and/or an integrated or external keypad 128, among other components. A user interface module may be configured to operate with the display 122, the keypad 128, etc. through a dedicated communications link or through one or more serial data interconnects.

The processing circuit 102 may provide one or more buses 130a, 130b, and 132 that enable certain ones of the devices 104, 106, and/or 108 to communicate. In one example, the ASIC 104 may include the bus interface circuit 118 that includes a combination of circuits, counters, timers, control logic, and other configurable circuits or modules. In one example, the bus interface circuit 118 may be configured to operate in accordance with communications specifications or protocols. The processing circuit 102 may include or control a power management function that configures and manages the operation of the apparatus 100.

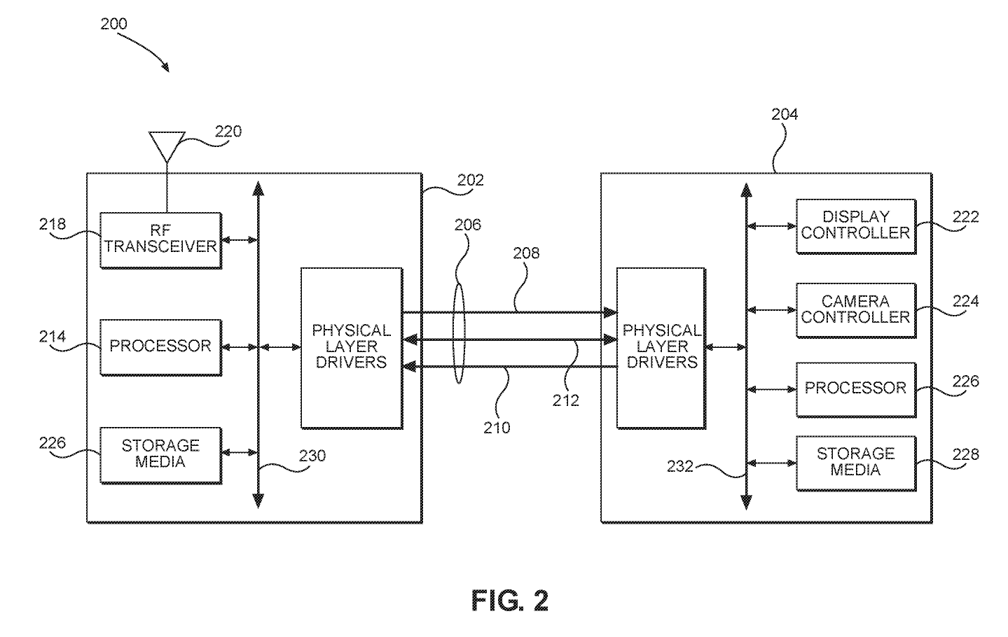

FIG. 2 is a block schematic diagram illustrating certain aspects of an apparatus 200, such as the apparatus 100 of FIG. 1, which may be a mobile computing device, a mobile telephone, a cordless telephone, a notebook computer, a tablet computing device, a media player, a gaming device, a wearable computing device, an appliance, or the like. The apparatus 200 may include a plurality of IC devices 202 and 204 that exchange data and control information through a communications link 206. The communications link 206 may be used to connect two or more of the IC devices 202 and 204 that are located in close proximity to one another, or that are physically located in different parts of the apparatus 200. In one example, the communications link 206 may be provided on a chip carrier, substrate, or circuit board that carries the IC devices 202 and 204. In another example, a first IC device 202 may be located in a keypad section of a smartphone or flip-phone while a second IC device 204 may be located in a display section of the flip-phone, on a touchscreen display panel, etc. In another example, a portion of the communications link 206 may include a cable or optical connection.

The communications link 206 may have multiple individual communications links 208, 210 and 212. The communications link 212 may include bidirectional connectors and may operate in time division, half-duplex, full-duplex, or other modes. One or more of the communications links 208 and 210 may include unidirectional connectors. The communications link 206 may be asymmetrically configured, providing higher bandwidth in one direction and/or between different ones of the IC devices 202 and 204. In one example, a first communications link 208 between the two IC devices 202 and 204 may be referred to as a forward link 208 while a second communications link 210 between the two IC devices 202 and 204 may be referred to as a reverse link 210. In another example, the first IC device 202 may operate or be designated as a host, manager, master, and/or transmitter, while one or more other IC devices 204 may be designated as a client, slave, and/or receiver, even if both of the IC devices 202 and 204 are configured to transmit and receive on the communications link 208. In one example, the communications link 208 may operate at a higher data rate when communicating data from the first IC device 202 to the second IC device 204 than a data link provided between the first IC device 202 and a third IC device (not shown).

The IC devices 202 and 204 may each include a general-purpose processor, multi-node processor, or other processing and/or computing circuit or device 214 and 216 adapted to cooperate with various circuits and modules to perform certain functions disclosed herein. The IC devices 202 and 204 may perform different functions and/or support different operational aspects of the apparatus 200. A plurality of IC devices, including the IC devices 202 and 204 may include modems, transceivers, display controllers, user interface devices, Bluetooth interface devices, audio/visual systems, digital-to-analog converters, analog-to-digital converters, memory devices, processing devices, and so on. In one example, the first IC device 202 may perform core functions of the apparatus 200, including maintaining communications through a radio-frequency (RF) transceiver 218 and an antenna 220, while the second IC device 204 may support a user interface that manages or operates a display controller 222, and/or may control operations of a camera or video input device using a camera controller 224. Other features supported by one or more of the IC devices 202 and 204 may include a keyboard, a voice-recognition component, application processors (APs), and various input or output devices. The display controller 222 may have circuits and software drivers that support displays such as a liquid crystal display (LCD) panel, touch-screen display, indicators, and so on. Storage media 226 and 228 may include transitory and/or non-transitory storage devices adapted to maintain instructions and data used by the respective processors 214 and 216, and/or other components of the IC devices 202 and 204. Communication between each processor 214 and 216 and its corresponding storage media 226 and 228 and other modules and circuits may be facilitated by one or more buses 230 and 232, respectively.

Different ones of the communications links 208, 210 and/or 212 may be capable of transmitting at comparable speeds or at different speeds, where speed may be expressed as a data transfer rate and/or clocking rates. Data rates may be substantially the same or differ by orders of magnitude, depending on the application. In some applications, a single bidirectional communications link 212 may support communications between the first IC device 202 and the second IC device 204. The forward link 208 and/or the reverse link 210 may be configurable to operate in a bidirectional mode and the forward and reverse links 208 and 210 may share the same physical connections, connectors, and/or wires. In one example, the communications link 206 may be operated to communicate control, command, and other information between the first IC device 202 and the second IC device 204 in accordance with an industry or other standard.

Industry standards may be application specific. In one example, the Mobile Industry Processor Interface (MIPI) standard defines physical layer interfaces, including the SLIMbus interface that may be used to provide an interface between an AP IC device 202 and an IC device 204 that supports functional elements and modules of a mobile device, including a camera, display, media player, etc.

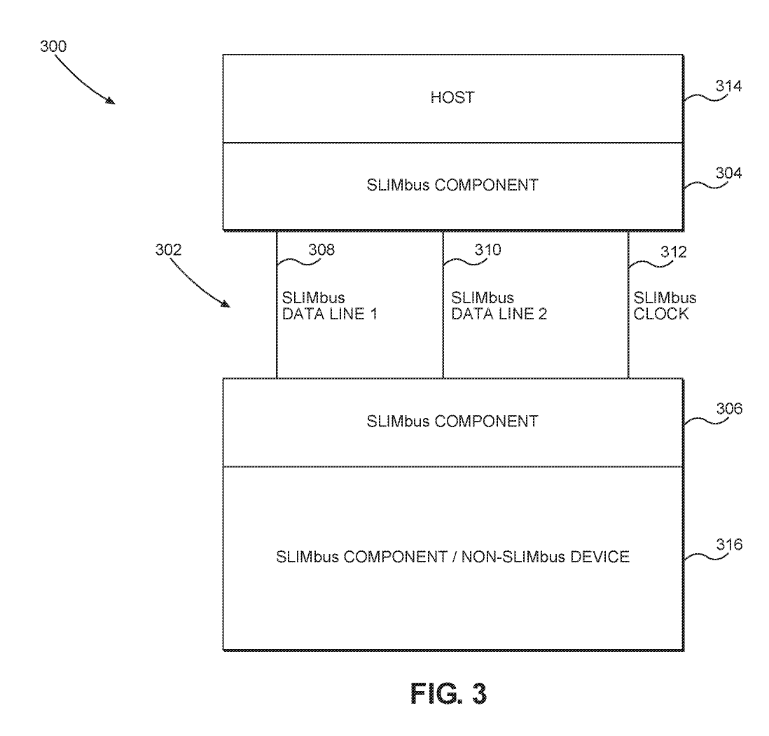

FIG. 3 is a simplified block diagram of a system 300 that illustrates a SLIMbus communications link 302 provided between SLIMbus components 304 and 306. The SLIMbus communications link 302 may include a plurality of SLIMbus data lines 308 and 310 deployed between the SLIMbus components 304 and 306. As further described herein, the SLIMbus communications link 302 may be adapted or configured to provide more than two data lines as desired or as needed to obtain a desired bandwidth and throughput on the SLIMbus communications link 302.

The SLIMbus communications link 302 may include a SLIMbus clock line 312 that has a frequency selected by dividing a “root clock” frequency. In some example, the root clock may have a frequency of, for example 24.576 megahertz (MHz) or more. In some examples, the frequency of the SLIMbus clock line 312 may be selected by using one of ten (10) available clock gears. Clock gears may divide the clock frequency by powers of two (2). In one example, the SLIMbus clock line 312 may have a frequency (f_{CLK}) calculated using the equation:

$${f}_{CLK} = \frac{{f}_{ROOT}}{{2}^{10 - G}}$$

where f_{ROOT} is the frequency of the root clock and G is the gear selected. Gear values may range from 1 to 10, with a value of 1 being the mode associated with minimum frequency and a value of 10 being the mode associated with maximum frequency. In this configuration, the maximum clock frequency is selected when G=10 and the maximum clock frequency is equal to the frequency of the root clock.

The system 300 may include a host 314 coupled to a first SLIMbus component 304. The first SLIMbus component 304 may be coupled to a second SLIMbus component 306 using the SLIMbus communications link 302, which may include one or more of a first SLIMbus data line 308 and a second SLIMbus data line 310. The second SLIMbus component 306 may be coupled to a third component 316, which may include a SLIMbus component or a non-SLIMbus device.

The host 314 may include a processing circuit that has one or more of a DSP, a central processing unit (CPU), a graphics processing unit (GPU), a microprocessor, or any combination thereof. The host 314 may include a mobile station modem (MSM), a mobile data modem (MDM), a radio frequency transceiver (RTR), an AP, or any combination thereof. The first SLIMbus data line 308 may support a first bandwidth and the second SLIMbus data line 310 may support a second bandwidth. In one example, the first SLIMbus data line 308 and the second SLIMbus data line 310 may be clocked at the same frequency, and the first SLIMbus data line 308 and the second SLIMbus data line 310 may carry data at the same data rate. In another example, the first SLIMbus data line 308 may have a greater bandwidth than the second SLIMbus data line 310. In another example, the second SLIMbus data line 310 may have a greater bandwidth than the first SLIMbus data line 308, when the second SLIMbus data line 310 and the first SLIMbus data line 308 are clocked at different rates. In the latter example, the first bandwidth may be 28 megabits per second (Mbps) and the second bandwidth may be greater than 28 Mbps. Throughput on one or more of the first SLIMbus data line 308 and the second SLIMbus data line 310 may be decreased when the first SLIMbus data line 308 and/or the second SLIMbus data line 310 carries control information.

Each of the plurality of SLIMbus data lines 308 and 310 may be a bidirectional data line. In some examples, one of the SLIMbus data lines 308 or 310 may be a bidirectional data line while the second SLIMbus data line 310 or 308 may be a unidirectional data line. As used herein, a bidirectional data line may be a data line that is capable of sending data in different directions between two or more devices. Further, each of the plurality of SLIMbus data lines 308 and 310 may be utilized to transmit data associated with a different power level. For example, the first SLIMbus data line 308 may be utilized for low-power traffic while the second SLIMbus data line 310 may be utilized for higher-power traffic. A power budget may be in effect for certain types of traffic. Power consumption may be managed or controlled in certain applications by configuring one or more of a transmit clock frequency, an encoding process used to encode data for transmission on the SLIMbus data line 308 or 310, data compression ratios, type of data encoded, and so on.

During operation, data may be sent from the first SLIMbus component 304 to the second SLIMbus component 306. As used herein, data may include audio data, non-audio data, pulse-code modulation (PCM) audio data, Sony Philips Digital Interface (SPDIF) data, High Definition Audio (HDA) data, professional audio data (i.e., 192 kilohertz (kHz), 24 bit as used in Dolby Surround 5.1/7.1, and certain Roland Music systems), or any combination thereof. The first SLIMbus component 304 may send data on one or more SLIMbus data lines selected from the plurality of SLIMbus data lines 308 and 310. For example, the data may be sent via the first SLIMbus data line 308, the second SLIMbus data line 310, or any combination thereof.

In accordance with certain aspects disclosed herein, the first SLIMbus component 304 may send data in parallel over multiple SLIMbus data lines 308 and 310 or send the data serially over a single SLIMbus data line 308 or 310. Whether the data is sent in parallel or serially may depend on factors such as a size of the data, a clock frequency of at least one SLIMbus data line, a compatibility of the data with the SLIMbus data transmission protocol, a priority of the data, a quality of service requirement, or based on any combination of these and/or other factors.

The first SLIMbus component 304 may send data in parallel using the first SLIMbus data line 308 and the second SLIMbus data line 310. In one example, the data may be divided into two portions, and the portions may be transmitted concurrently, or substantially concurrently, over the SLIMbus data lines 308 and 310. Upon receipt, the data may be interleaved and/or concatenated. In another example, the data may be divided into two portions and the first SLIMbus component 304 may send the data serially over one of the first SLIMbus data line 308 and the second SLIMbus data line 310. In some instances, the two portions of data may be transmitted sequentially over either the first SLIMbus data line 308 or the second SLIMbus data line 310. The data may be sent in accordance with a SLIMbus data transmission protocol, a time-division transmission protocol, or a non-time-division transmission protocol.

According to certain aspects disclosed herein, the third component 316 may be configured to be compatible with a configuration that supports the plurality of SLIMbus data lines 310 and 310, as described herein. For example, the third component 316 may be configured to receive data from the first SLIMbus component 304 over the plurality of SLIMbus data lines 308 and 310. Certain data sent to the third component 316 may be transmitted in accordance with a non-SLIMbus protocol, which may be a non-time-division protocol or a time-division protocol other than the SLIMbus data transmission protocol.

According to certain aspects disclosed herein, data transmitted over each SLIMbus data line 308 and 310 may correspond to different SLIMbus components. For example, the first and second SLIMbus components 304 and 306 may be configured to receive and transmit data using the first SLIMbus data line 308 and the SLIMbus clock line 312, while third and fourth SLIMbus components may be configured to receive and transmit data using the second SLIMbus data line 310 and the SLIMbus clock line 312. The same SLIMbus clock line 312 may control timing and rates of data transfer between different components or sets of components that each use a different one of the SLIMbus data lines 308 and 310.

A SLIMbus device may be restricted or configured for connection to a single SLIMbus data line 308 or 310. In some examples, one or more SLIMbus components 304 and 306 may be connected to a plurality of available SLIMbus data lines 308 and 310, and may be connected to a single SLIMbus clock line 312. In addition, devices configured for compatibility with multiple SLIMbus data lines may coexist in the system 300 with legacy devices that support only one SLIMbus data line.

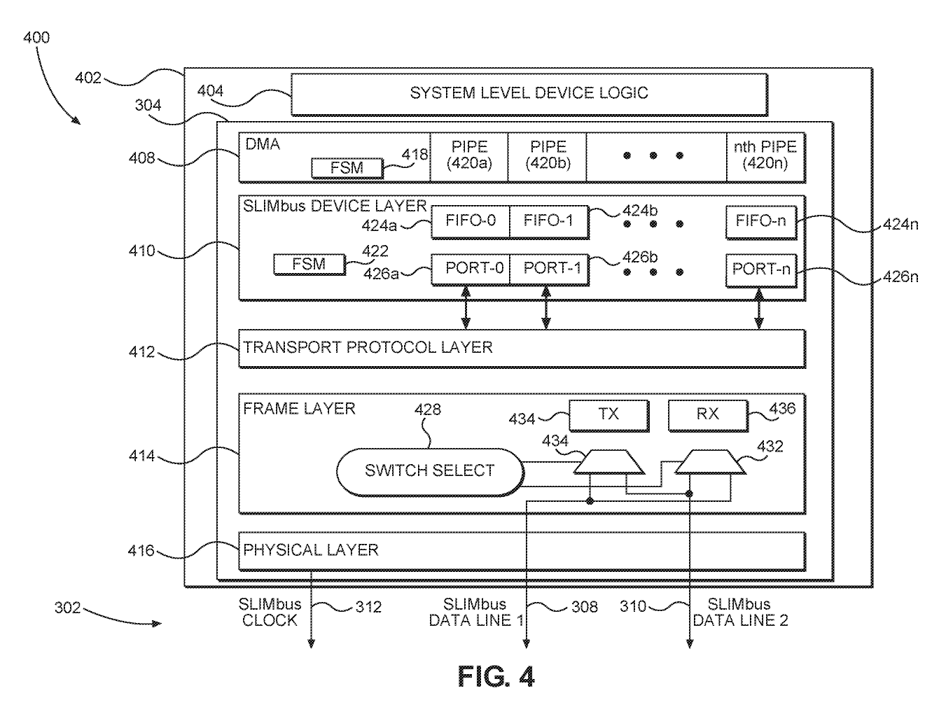

FIG. 4 illustrates an apparatus 400 adapted to communicate over the SLIMbus communications link 302 of FIG. 3. In the example, the apparatus 400 includes an IC device 402 that can be adapted to communicate with one or more other IC devices (not shown) using the plurality of SLIMbus data lines 308 and 310 and the SLIMbus clock line 312.

The IC device 402 may correspond to a functional component implemented using one or more modules or circuits, such as a processing circuit or device, a coder/decoder (Codec), an input device, an output device, etc. The IC device 402 may include the SLIMbus component 304 or 306 illustrated in FIG. 3, in addition to a system-level device logic 404. In one example, the IC device 402 operates as the SLIMbus component 304, and the host 314 includes the system-level device logic 404.

In one example, the IC device 402 may include a direct memory access (DMA) layer 408, a SLIMbus device layer 410, a transport protocol layer 412, a frame layer 414, and a physical layer 416. The DMA layer 408 may include or be implemented by a processing circuit such as a first finite state machine (FSM) 418, a sequencer, or other processing circuit or device. The DMA layer 408 may include a plurality of pipes, including a first pipe 420a and a second pipe 420b. The plurality of pipes may include additional pipes up to an nth pipe 420n. The plurality of pipes may be configured as one or more message channels that transmit messages such as data messages and/or user-defined configuration messages.

The SLIMbus device layer 410 may be a generic device layer, an interface device layer, a framer device layer, a manager device layer, or any combination thereof. The SLIMbus device layer 410 may include a processing circuit such as a second FSM 422, one or more First-In-First-Out (FIFO) buffers and one or more ports, which may also be referred to as message ports. In one example, the SLIMbus device layer 410 may include a first FIFO buffer 424a, a second FIFO buffer 424b, and other FIFO buffers up to an nth FIFO buffer 424n, a first port (Port-0) 426a, a second port (Port-1) 426b, and other ports up to an nth port (Port-n) 426n. Each port 426a-426n may be connected to a corresponding FIFO buffer 424a-424n. For example, the first port 426a may be connected to the first FIFO buffer 424a, the second port 426b may be connected to the second FIFO buffer 424b, and so on, until the nth port 426n, which may be connected to the nth FIFO buffer 424n.

In some examples, each port 426a-426n may be coupled to two FIFO buffers 424a-424n, which may enable and/or support bi-directional data transfer capabilities of each individual port 426a-426n. For example, the first port 426a may be connected to the first FIFO buffer 424a and the second FIFO buffer 424b. In addition, the ports may support asynchronous connections thereby making more ports available to the apparatus 400. It will be appreciated that the use of dual-FIFO ports may effectively double an overall number of available ports in a system, because a single pair of ports may be used for bi-directional communication between two devices instead of using a dedicated pair of uplink ports and a dedicated pair of downlink ports.

The frame layer 414 may generate a switch select signal 428 and may include a first multiplexer 430 and a second multiplexer 432. The first multiplexer 430 may be associated with data transmission 434 and the second multiplexer 432 may be associated with data reception 436. The switch select signal 428 may cause the first multiplexer 430 to transmit data via the first SLIMbus data line 308, the second SLIMbus data line 310, or any combination thereof. Alternatively or additionally, the switch select signal 428 may cause the second multiplexer 432 to receive data via the first SLIMbus data line 308, the second SLIMbus data line 310, or any combination thereof.

In some configurations, the frame layer 414 may include a single multiplexer 430 or 432. For example, the IC device 402 may include two frame layers 414, each including a single multiplexer 430 or 432. In another example, the transport protocol layer 412 may include the first multiplexer 430 and the second multiplexer 432, and an additional SLIMbus clock line may be used. However, because the additional SLIMbus clock line may consume more power than a SLIMbus data line, implementations involving multiple SLIMbus clock lines may be avoided to reduce power consumption. In one example, the SLIMbus clock line 312 may account for 60-70% of total power consumption attributable to the SLIMbus communications link 302.

SLIMBUS Interrupts

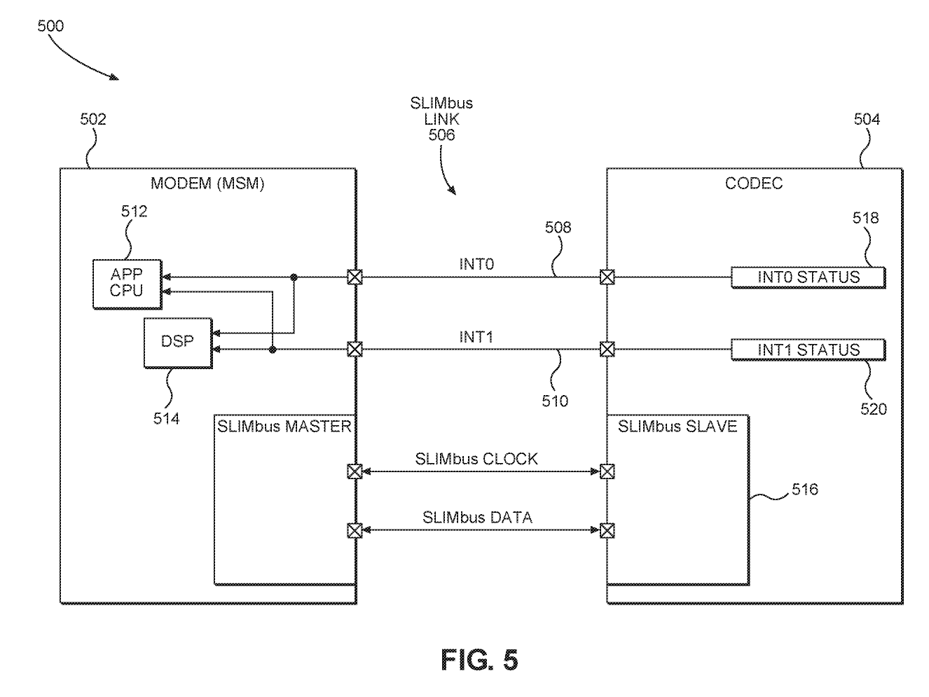

Certain SLIMbus interfaces provide interrupt capabilities by allocating one or more GPIO circuits to carry interrupt signals. FIG. 5 illustrates a system 500 that includes a modem 502 and a Codec 504 that communicate through a SLIMbus communications link 506 that includes interrupt lines 508 and 510 in the audio data path. The modem 502 may be referred to as a Mobile Station Modem (MSM) and may be implemented on a SoC or other ASIC. The modem 502 includes two processors 512 and 514. Note that one or both of the processors 512 and 514 may be multi-core processors. Each processor 512 and 514 may be interrupted through a dedicated interrupt line 508 or 510. A first processor 512 may be an AP that is associated with a first interrupt line 508, and a second processor 514 may be a DSP that is associated with a second interrupt line 510. As illustrated in FIG. 5, both processors 512 and 514 may monitor interrupt signaling, or be capable of being interrupted by signaling on both interrupt lines 508 and 510.

Applications executed or supported by the processors 512 and 514 may communicate through the SLIMbus communications link 506. The modem 502 may include a SLIMbus master function or circuit that communicates messages and other data payloads between both processors 512 and 514 and the Codec 504. The Codec 504 may include a function or circuit that operates as a SLIMbus slave 516 and receives and responds to the messages and other data payloads received from both processors 512 and 514 in the modem 502, and that may transmit messages and other data payloads to the modem 502. The Codec 504 may assert interrupts over the corresponding interrupt lines 508 and 510 based on an interrupt status maintained by interrupt status registers 518 and 520.

The physical interrupt lines 508 and 510 consume GPIO on both the modem 502 and the Codec 504 for each interrupt. Typically, each processor 512 and 514 is supported by at least one interrupt line 508 or 510. In systems that include more than two processors, GPIO consumption can increase cost, pin count, and routing difficulties to alert each processor in the modem 502, or in another host device. Interrupt signals indicate occurrence of an alert and do not carry specific information regarding the source of the interrupt and/or cause of the interrupt. That is, interrupt information is not carried in-line or in-band on the interrupt lines 508 and 510. In response to assertion of an interrupt, the respective processor 512 or 514 queries the Codec 504 to ascertain the type of interrupt and any specific interrupt-related parameters, using an agreed-upon communications protocol. The process of ascertaining the source of interrupts can prolong interrupt handling processes and result in increased power consumption. System efficiency may be negatively impacted by prolonged interrupt handling processes.

Interrupt processing can be further complicated when low-power modes are in effect or initiated on devices coupled to a SLIMbus. If an event requiring an alert occurs during power-down modes and/or SLIMbus shut-down, specific devices, circuits, and functions are awakened to respond to an interrupt assertion. In one example, one or more protocols unrelated to an interrupt handling protocol are awakened after assertion of an interrupt. In various examples, a communication protocol unrelated to the interrupt handling protocol and associated circuits are awakened to interrogate a slave device and/or receive interrupt information used to determine a response to the interrupt. The wake-up processes can further prolong interrupt handling processes and increase power consumption.

SLIMBUS in-Band-Interrupts

According to certain aspects disclosed herein, IBIs may replace interrupts asserted on physical interrupt lines. FIG. 6 illustrates a system 600 that includes a modem 602 and a Codec 604 that communicate through a SLIMbus communication link 606 where the physical interrupt lines 508 and 510 can be eliminated. IBIs may be communicated using SLIMbus messages. A hardware message generator 608 may be provided in a SLIMbus slave 610 of the Codec 604 that has been adapted in accordance with certain aspects disclosed herein. The message generator 608 generates IBI messages based on a type of interrupt that has been detected, as recorded in local sticky registers 612 and 614. A sticky register may capture and hold interrupt events that can be transitory in nature (e.g., a clock edge). Each IBI message may be transmitted as an in-band RPT_INFO message, and may include information identifying devices that are the source and destination of the IBI, a type of interrupt, and full interrupt-status register information, which may include 1-16 bytes. The IBI messages carry sufficient information to enable selection of an appropriate interrupt handler without re-reading slave status. Interrupt status bits stored in the local sticky registers 612 and 614 may be cleared upon acknowledged receipt by a master 616 in the modem 602 of an IBI message corresponding to the status bits, and/or upon initiation of an interrupt handler in the modem 602. It should be appreciated that the appropriate interrupt handler may be one of the cores of a multi-core processor in the master 616.

The master 616 may include a configurable hardware message parser 618, which may be managed and/or configured under software control. The message parser 618 may be configured to extract information from an IBI message, including a source of the interrupt. The message parser 618 may be configured to map interrupts to associated processors 620 and 622, or and/or an associated execution environment. The message parser 618 may be configured to store a local interrupt status using sticky bit registers 624. The master 616 may exert local control of each interrupt bit, which can be read cleared and masked. The master 616 may wake up the relevant processor 620 or 622 (or the relevant core of a multi-core processor) based on the received interrupt.

The use of IBI messages may conserve pins on the devices 602 and 604 of the system 600. The IBI messages enable interrupts to be carried over the SLIMbus communication link 606 provided in the system 600. The use of IBI messages may reduce latency and save interrupt processing time since the in-band message can carry more complete interrupt information.

IBI messages may be formatted in accordance with SLIMbus specifications for transmitting messages in a SLIMbus message channel. An IBI message that delivers an IBI may conform to the RPT_INFO message, which includes:
SRC (Source Address)—[Device type: Coded]
DST (Destination Address)—[default: Modem Manager]
EC (Element Code)—[identify Information Element]
IS (Information Slice)—[1-16 Bytes: Information Element content]

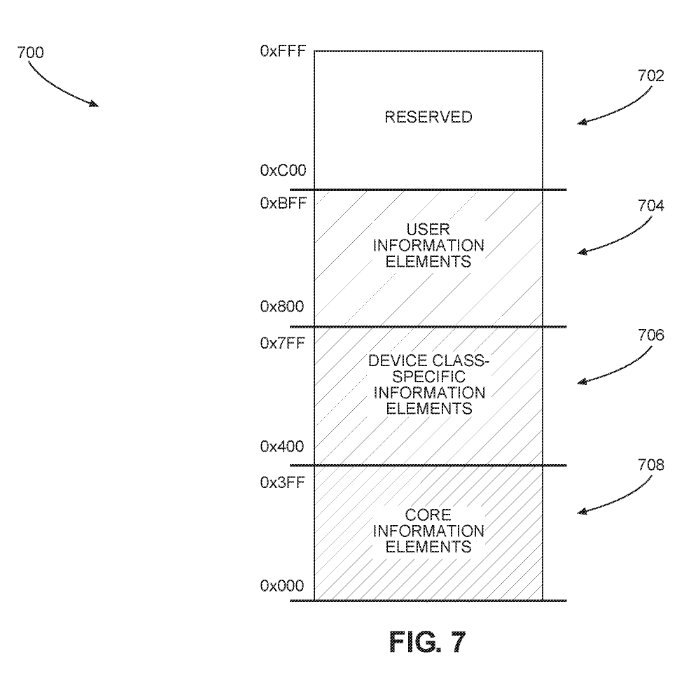

SLIMbus messages may be identified based on their location in a SLIMbus Information Map 700, as illustrated in FIG. 7. The SLIMbus information map 700 includes reserved bits 702, user information element bits 704, device class-specific information elements 706, and core information element bits 708. In one implementation, the low addresses of the user information element bits 704 may be dedicated to different interrupt-status values. For example, each interrupt may correspond to an address space of 16-Bytes:
0x800-0x80F—INT0 interrupt-status, use up to 16-Bytes
0x810-0x81F—INT1 interrupt-status, use up to 16-Bytes

When an internal interrupt event is detected, (through assertion of internal IntN signal for example), the SLIMbus slave 610 in the Codec 604 of FIG. 6 may generate a RPT_INFO message targeting the active manager, with the respective EC and the relevant interrupt-status.

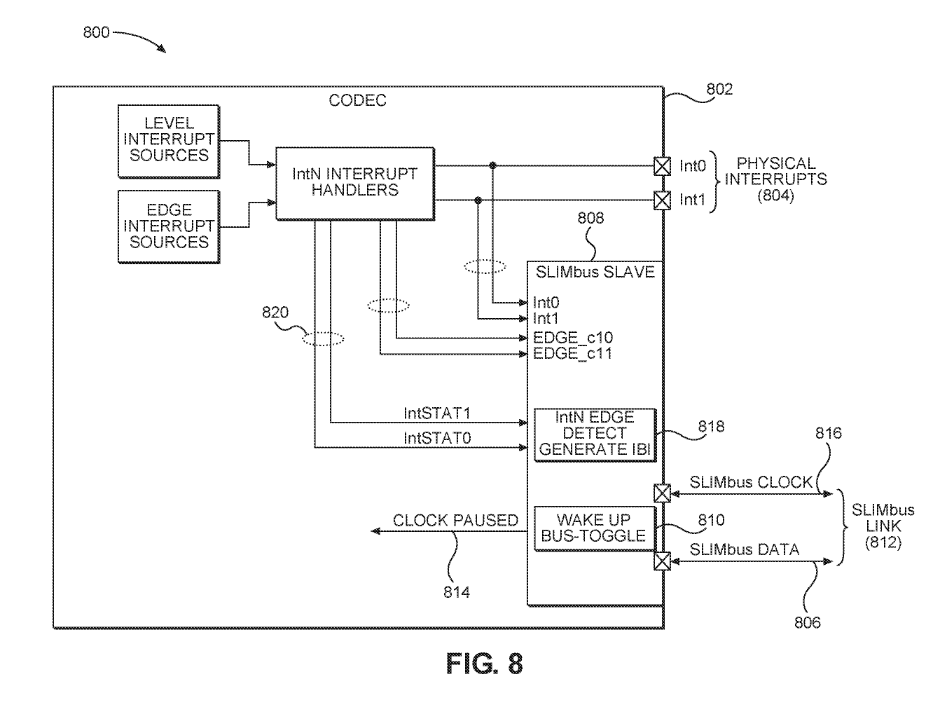

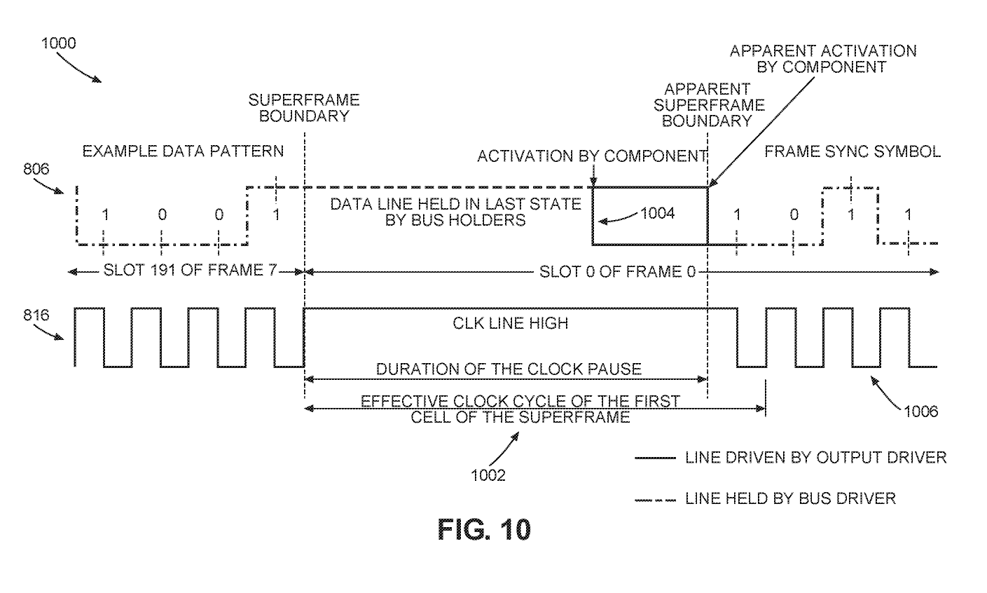

According to certain aspects, the use of IBI messages can conserve system power and reduce response latencies when wake up and an interrupt message are combined. FIG. 8 illustrates a system 800 in which a Codec 802 is configured to combine wake up and interrupts. External INT0, INT1 outputs 804 may be eliminated. As illustrated in the timing diagram 1000 of FIG. 10, discussed later, SLIMbus standards provide a mechanism for waking up an interface when a device toggles SLIMbus data line 806. A SLIMbus slave 808 in the Codec 802 may include a wake-up circuit 810 that toggles the SLIMbus data line 806 when SLIMbus link 812 is in a power-down mode. The SLIMbus slave 808 may provide a signal 814 that indicates when the clock signal received from SLIMbus clock line 816 has been paused, indicating a power-down mode of operation for example. An IBI message generator 818 may then create and transmit an IBI message appropriate for an interrupt status 820 for the Codec 802. The IBI message may include an in-band RPT_INFO message that carries information regarding source and destination devices associated with the interrupt, a type of the interrupt, and the full interrupt-status register information. The SLIMbus slave 808 may support a configurable number of interrupts (N interrupts), a configurable interrupt-status width (e.g., 1-16 bytes), masking each IntN signal, and/or configurable destination for each IntN.

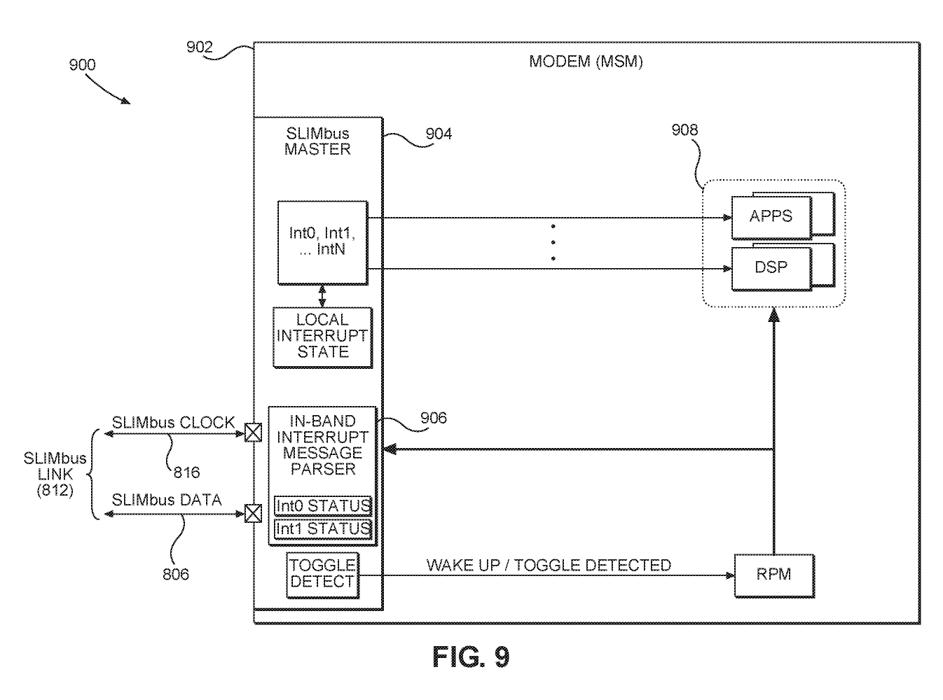

FIG. 9 illustrates a system 900 in which a modem 902 is configured to support IBI messages in a SLIMbus master 904. A configurable message parser 906 may monitor the source of each interrupt, map interrupts to one or more appropriate processors 908 (or cores within a multi-core processor), and maintain local interrupt status using sticky interrupt-bit registers. Interrupt status may be under local control, whereby each interrupt-bit can be read cleared and masked.

Regarding the timing diagram 1000 of FIG. 10, when the SLIMbus link 812 is in a clock pause mode (generally at 1002), the Codec 802 may wake up a framer circuit to restart the clock signal transmitted on the SLIMbus clock line 816 by asserting a ‘bus-toggle’ 1004 on the SLIMbus data line 806. The device may continue to drive the SLIMbus data line 806 until a negative edge in the clock signal is observed on the SLIMbus clock line 816. The active Framer may then resume the clock signal 1006.

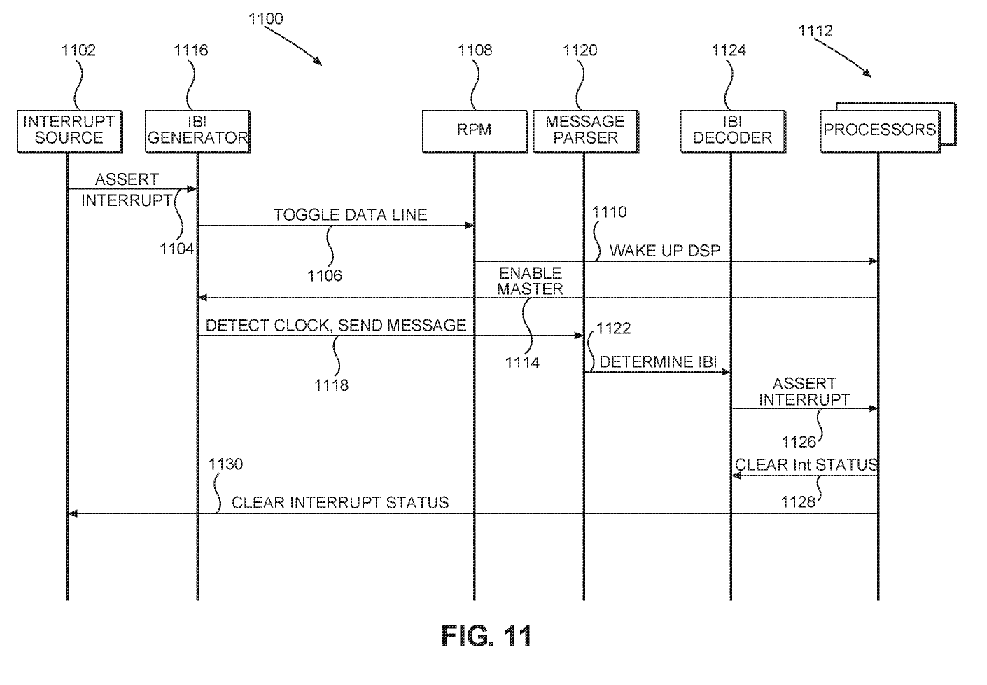

FIG. 11 is a flow diagram 1100 illustrating the operation of a system that employs IBI messages in accordance with certain aspects disclosed herein. Initially, the system may be in a power-down mode. An interrupt source 1102 may assert an interrupt 1104, thereby generating an initial event. The interrupt source 1102 may include a codec Interrupt handler. When the SLIMbus is not active and in clock pause mode, a wake-up request is generated. The wake-up request may take the form of a SLIMbus data line toggle 1106, which causes a power management circuit, such as a Resource Power Manager (RPM 1108) to generate a signal or message 1110 that causes one or more processors 1112 to awaken. The one or more processors 1112 may include a DSP that is adapted to wake and configure 1114 a framer and/or a SLIMbus master, and thereby to restart the clock signal. An IBI generator 1116 having detected an edge in one of the interrupt signals may generate and send an IBI message 1118 over the SLIMbus, with content corresponding to the asserted interrupt signal. The information may include a device source, which may be the codec or a component of the codec, the destination (the manager), an Interrupt Identity (e.g., 0x800 for INT0 and 0x810 for INT1) and an interrupt status corresponding to the asserted interrupt. A message parser 1120 in the master may be configured to determine 1122 if the message is part of the configured IBIs, (e.g. EC=0x800, 0x810) and may extract the interrupt status value from the IBI message in an IBI decoder 1124 circuit or function. The IBI decoder 1124 may store the interrupt status value in local registers, and if not masked, assert 1126 the local-INTn signal.

When either the DSP or the AP receives an interrupt signal, then it reads the interrupt status from the local registers and adds the interrupt status to an Interrupt Controller Queue. In some implementations, the local copy of the interrupt status stored in the local registers can be cleared 1128 immediately after the interrupt status has been added to the queue. After software has handled a specific interrupt-bit which is a level interrupt indicating events in one or more sources, the relevant source (or cause) bits can be cleared 1130. Only those bits in the remote interrupt status are cleared after the software handling has been completed. When software has completed handling all pending interrupt bits sent in the previous IBI message, relevant edge detect bits in registers may be cleared by either writing to the clear register of the interrupt handler, which may generate a clear pulse or directly clear the bit inside the SLIMbus registers.

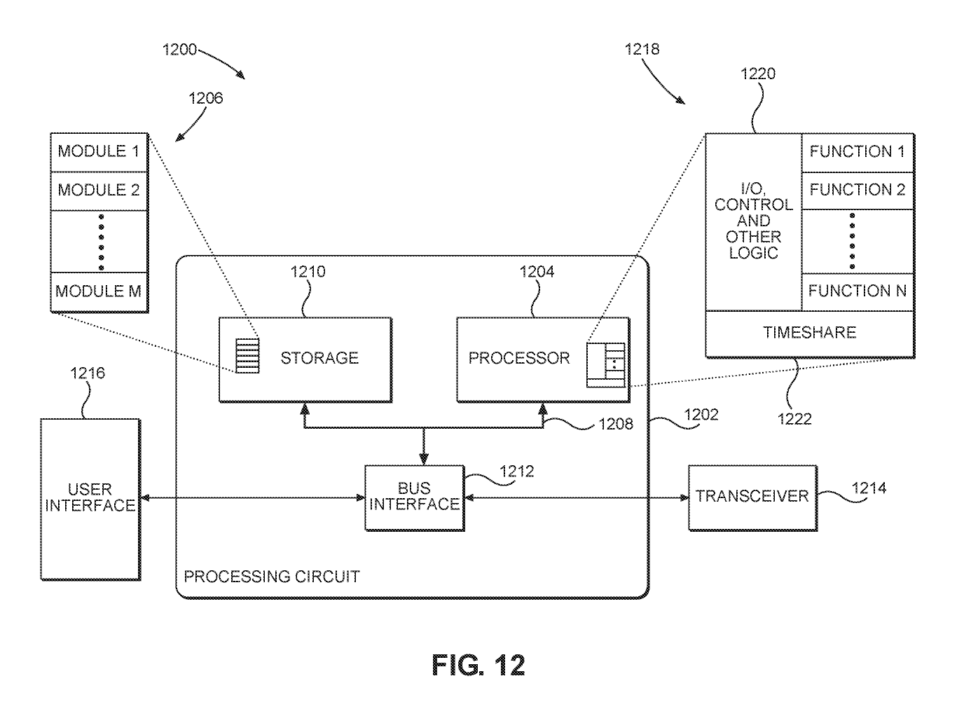

FIG. 12 is a conceptual diagram 1200 illustrating a simplified example of a hardware implementation for an apparatus employing a processing circuit 1202 that may be configured or adapted according to certain aspects disclosed herein. In accordance with various aspects of the disclosure, an element, or any portion of an element, or any combination of elements as disclosed herein may be implemented using the processing circuit 1202. The processing circuit 1202 may include one or more processors 1204 that are controlled by some combination of hardware and software modules. Examples of the one or more processors 1204 include microprocessors, microcontrollers, DSPs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented, or controlled by one of software modules 1206. The one or more processors 1204 may be configured through a combination of the software modules 1206 loaded during initialization, and further configured by loading or unloading one or more of the software modules 1206 during operation.

In the illustrated example, the processing circuit 1202 may be implemented with a bus architecture, represented generally by a bus 1208. The bus 1208 may include any number of interconnecting buses and bridges depending on the specific application of the processing circuit 1202 and the overall design constraints. The bus 1208 links together various circuits, including the one or more processors 1204 and storage 1210. The storage 1210 may include memory devices and mass storage devices, and may be referred to herein as computer-readable media and/or processor-readable media. The bus 1208 may also link various other circuits such as timing sources, timers, peripherals, voltage regulators, and power management circuits. A bus interface 1212 may provide an interface between the bus 1208 and one or more transceivers 1214. A transceiver 1214 may be provided for each networking technology supported by the processing circuit. In some instances, multiple networking technologies may share some or all of the circuitry or processing modules found in the transceiver 1214. Each transceiver 1214 provides a means for communicating with various other apparatus over a transmission medium. Depending upon the nature of the apparatus, a user interface 1216 (e.g., keypad, display, speaker, microphone, joystick) may also be provided, and may be communicatively coupled to the bus 1208 directly or through the bus interface 1212.

A processor 1204 may be responsible for managing the bus 1208 and for general processing that may include the execution of software stored in a computer-readable medium that may include the storage 1210. In this respect, the processing circuit 1202, including the processor 1204, may be used to implement any of the methods, functions and techniques disclosed herein. The storage 1210 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1210 or in an external computer-readable medium. The external computer-readable medium and/or the storage 1210 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital video disc (DVD)), a smart card, a flash memory device (e.g., a “flash drive,” a card, a stick, or a key drive), a RAM, a ROM, a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or the storage 1210 may also include, by way of example, a carrier wave, a transmission line, and any other suitable medium for transmitting software and/or instructions that may be accessed and read by a computer. The computer-readable medium and/or the storage 1210 may reside in the processing circuit 1202, in the processor 1204, external to the processing circuit 1202, or be distributed across multiple entities including the processing circuit 1202. The computer-readable medium and/or the storage 1210 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1210 may maintain software maintained and/or organized in loadable code segments, modules, applications, programs, etc., which may be referred to herein as software modules 1206. Each of the software modules 1206 may include instructions and data that, when installed or loaded on the processing circuit 1202 and executed by the one or more processors 1204, contribute to a run-time image 1218 that controls the operation of the one or more processors 1204. When executed, certain instructions may cause the processing circuit 1202 to perform functions in accordance with certain methods, algorithms, and processes described herein.

Some of the software modules 1206 may be loaded during initialization of the processing circuit 1202, and these software modules 1206 may configure the processing circuit 1202 to enable performance of the various functions disclosed herein. For example, some of the software modules 1206 may configure internal devices and/or logic circuits 1220 of the processor 1204, and may manage access to external devices such as the transceiver 1214, the bus interface 1212, the user interface 1216, timers, mathematical coprocessors, and so on. The software modules 1206 may include a control program and/or an operating system that interacts with interrupt handlers and device drivers, and that controls access to various resources provided by the processing circuit 1202. The resources may include memory, processing time, access to the transceiver 1214, the user interface 1216, and so on.

One or more processors 1204 of the processing circuit 1202 may be multifunctional, whereby some of the software modules 1206 are loaded and configured to perform different functions or different instances of the same function. The one or more processors 1204 may additionally be adapted to manage background tasks initiated in response to inputs from the user interface 1216, the transceiver 1214, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1222 that passes control of the processor 1204 between different tasks, whereby each task returns control of the one or more processors 1204 to the timesharing program 1222 upon completion of any outstanding operations and/or in response to an input such as an interrupt. When a task has control of the one or more processors 1204, the processing circuit 1202 is effectively specialized for the purposes addressed by the function associated with the controlling task. The timesharing program 1222 may include an operating system, a main loop that transfers control on a round-robin basis, a function that allocates control of the one or more processors 1204 in accordance with a prioritization of the functions, and/or an interrupt-driven main loop that responds to external events by providing control of the one or more processors 1204 to a handling function.

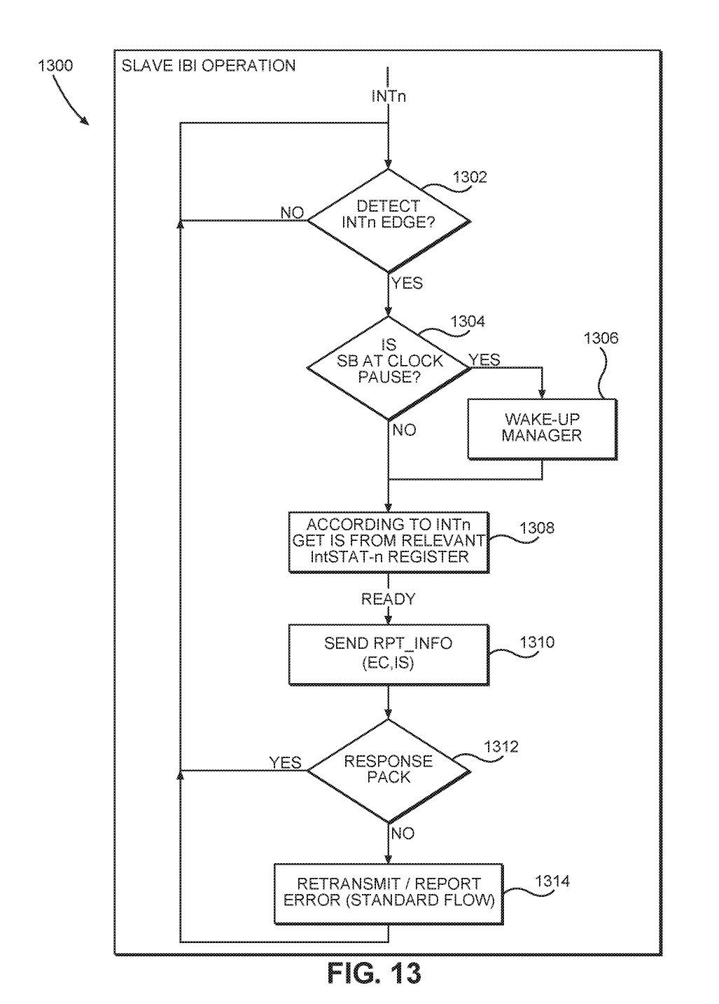

FIG. 13 is a flowchart of a process 1300 illustrating an example of IBI handling at a slave device. The process 1300 begins by detecting an interrupt edge (block 1302). An edge is detected when a variable such as INTn is changed from asserted to de-asserted or there is a cleaning of an INTn-edge-detect while INTn is asserted. So long as no edge is detected, the process 1300 repeats looking for the interrupt edge. Once an edge is detected, the process 1300 determines if the bus (SB) is at a clock pause (block 1304). If the answer at block 1304 is yes, then the process 1300 initiates the wake-up manager (block 1306). Otherwise, or after wake up, according to what source reported the interrupt (as defined by INTn), the process 1300 gets the information slice from the relevant IntStat-n register (block 1308). Note that the IntStat-n register includes the interrupt status information. The process 1300 continues sending the RPT_INFO including EC and the IS (block 1310). Note that the element code (EC) includes the relevant value indication relating to the specific ones of the interrupts (INTn) that were asserted (e.g., Interrupt Identity: 0x800 for INT0 and 0x810 for INT1). In other words, the EC indicates which interrupt signal (INTn) was asserted and the IS indicates what is the type of interrupt that caused this signal to alert. For example, a heat interrupt and a volume up button push may generate the same INT1 signal (making the EC=0x800, for example) and the value of the IntStat will include both events as an indication to the software. The type of INTn as reflected in the value of the EC will direct the IntStat value to the relevant software manager. The process 1300 continues by checking to see if a response acknowledgment (PACK) is received (block 1312). If the answer is no, then the RPT_INFO is resent with an error report (block 1314) and the process 1300 returns to block 1302.

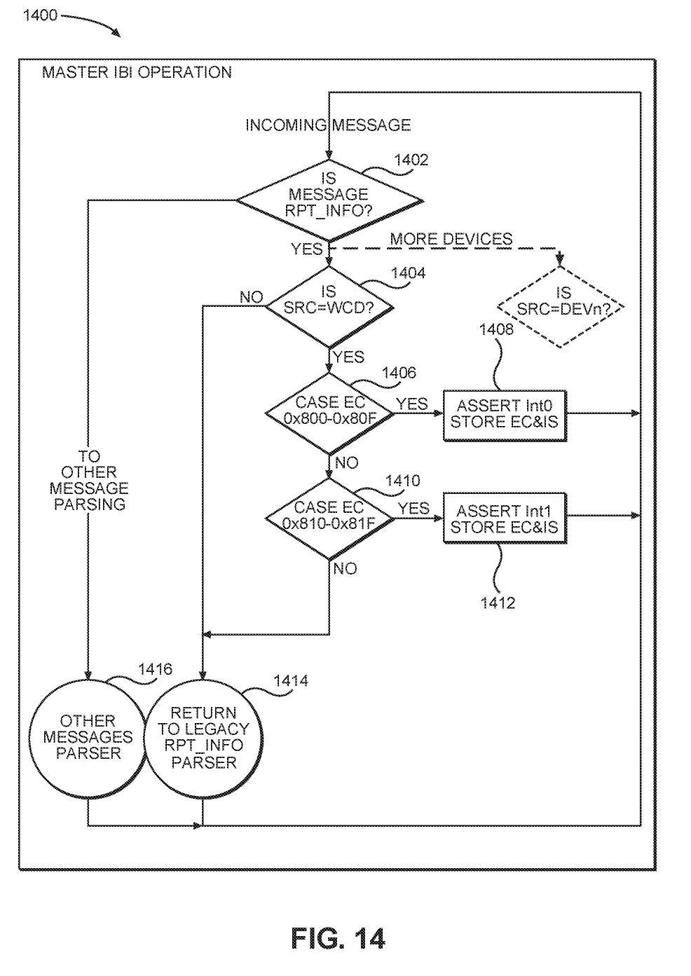

FIG. 14 is a flowchart of a process 1400 illustrating an example of IBI handling at a master device. The process 1400 begins by receiving an incoming message, to which the master determines if the incoming message is a RPT_INFO (block 1402). If the answer is yes, then the process 1400 determines if the source (SRC) is equal to a wired-codec-digital device (WCD) (block 1404). That is, the source information will indicate what device generated the interrupt message. The dotted line before block 1404 is representative of a determination of what the source is (i.e., source=device n?). If the answer to block 1404 is yes, then the process 1400 determines if the EC is in a certain range (e.g., 0x800-0x80F) (block 1406). As implemented, this range indicates the original signal was INT0. It should be appreciated that the range may be otherwise defined to achieve the same result. If the answer to block 1406 is yes, then the process 1400 asserts a first interrupt (INT0) and stores the EC and IS (block 1408). If the answer to block 1406 is no, then the process 1400 determines if the EC is between a second range (e.g., 0x810-0x81F) (block 1410). As implemented, this range indicates the original signal was INT1. It should be appreciated that the range may be otherwise defined to achieve the same result (e.g., the ranges could be reversed or have different values). If the answer to block 1410 is yes, then the process 1400 asserts a second interrupt (INT1) and stores the EC and IS (block 1412). If the answer to blocks 1404 or 1410 is no, then the process 1400 returns to a legacy RPT_INFO parser (block 1414). If the answer to block 1402 is no, then a parser for other messages is used (block 1416).

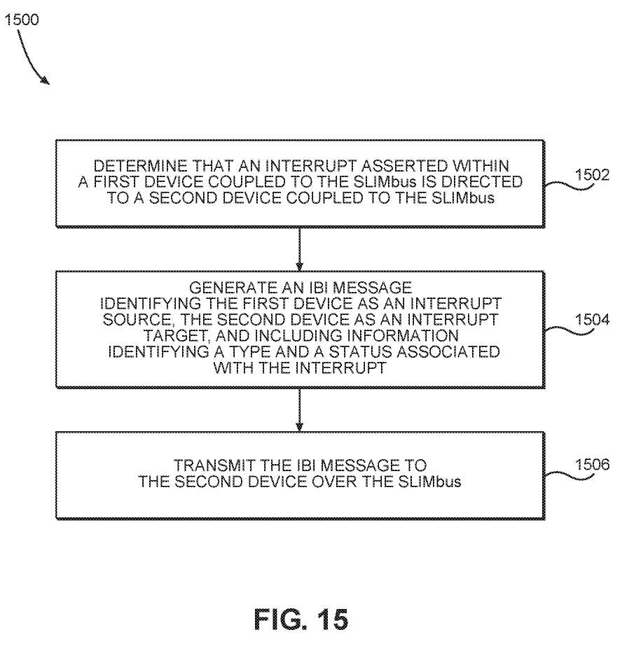

FIG. 15 is a flowchart 1500 illustrating a communications method according to certain aspects of the invention. The method may be performed at a slave device coupled to a SLIMbus.

At step 1502, the slave device may determine that an interrupt asserted within a first device coupled to the SLIMbus is directed to a second device coupled to the SLIMbus. It should be appreciated that the slave device may be an IC or a specific processor within an IC or a particular core within a multi-core processor.

At step 1504, the slave device may generate an IBI message identifying the first device as an interrupt source, the second device as an interrupt target, and including information identifying a type and a status associated with the interrupt.

At step 1506, the slave device may transmit the IBI message to the second device over the SLIMbus. As noted above, the IBI message may include information identifying the type and the status associated with the interrupt.

The slave device may determine that the SLIMbus is in a clock-stop or powered-down mode of operation when the interrupt is determined to be asserted. The slave device may toggle a data line of the SLIMbus prior to transmitting the IBI message to the second device.

The slave device may determine that a clock signal of the SLIMbus is active after toggling the data line of the SLIMbus and prior to transmitting the IBI message to the second device.

The slave device may store the status associated with the interrupt in a register, receive an interrupt acknowledgement from the second device, and clear the status associated with the interrupt in the register in response to the interrupt acknowledgement received from the second device.

The first device may be a coder/decoder circuit. The second device may be a DSP. The second device may be an AP.

In various examples, interrupts may be provided by one of a plurality of interrupt sources in the first device. The IBI message may include information distinguishing between potential sources of the interrupt. That is, the IBI message may specify the source of the interrupt. Interrupts may be provided as signals on interrupt request lines, the signals being driven by or derived from corresponding interrupt sources. The second device may include a plurality of processors, and the IBI message may include information identifying one of the plurality of processors as the interrupt target. That is, the IBI message may specify which processor should receive the interrupt. The second device may include circuits that drive one or more interrupt request lines in the second device based on information included in the IBI message.

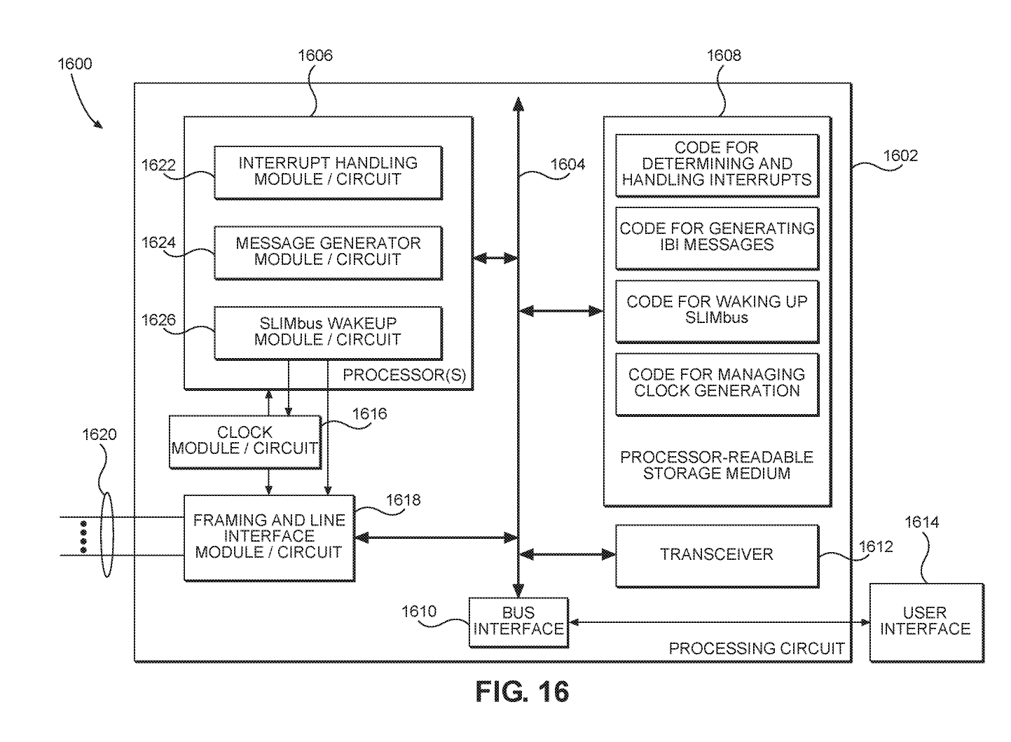

FIG. 16 is a conceptual diagram illustrating an example of a hardware implementation for an apparatus 1600 employing a processing circuit 1602. The apparatus 1600 may interface as a slave device on a serial bus, such as a SLIMbus. The apparatus 1600 may include a codec function. In this example, the processing circuit 1602 may be implemented with a bus architecture, represented generally by a bus 1604. The bus 1604 may include any number of interconnecting buses and bridges depending on the specific application of the processing circuit 1602 and the overall design constraints. The bus 1604 links together various circuits including one or more processors, represented generally by processor 1606, and computer-readable media, represented generally by the processor-readable storage medium 1608. The bus 1604 may also link various other circuits such as timing sources, timers, peripherals, voltage regulators, and power management circuits. A bus interface 1610 provides an interface between the bus 1604 and a transceiver 1612. The transceiver 1612 may include a bus interface that provides a means for communicating with various other apparatus over a transmission medium. Depending upon the nature of the apparatus, a user interface 1614 (e.g., keypad, display, speaker, microphone, joystick) may also be provided. One or more clock circuits or modules 1616 may be provided within the processing circuit 1602 or controlled by the processing circuit 1602 and/or one or more processors 1606. In one example, the clock circuits or modules 1616 may include one or more crystal oscillators, one or more phase-locked loop devices, and/or one or more configurable clock trees.

The processor 1606 is responsible for managing the bus 1604 and general processing, including the execution of software stored on the processor-readable storage medium 1608. The software, when executed by the processor 1606, causes the processing circuit 1602 to perform the various functions described above for any particular apparatus. The processor-readable storage medium 1608 may be used for storing data that is manipulated by the processor 1606 when executing software.

In one configuration, the apparatus 1600 includes a line interface module and/or circuit 1618 configured to couple the apparatus 1600 to a serial bus 1620. In the illustrated example, the serial bus 1620 may comply or be compatible with SLIMbus protocols and the line interface module and/or circuit 1618 may include a SLIMbus framer. The apparatus 1600 may include one or more interrupt sources, an interrupt handling module and/or circuit 1622, a message generator module and/or circuit 1624, and a SLIMbus wake-up module and/or circuit 1626.

In one example, the message generator module and/or circuit 1624 is configured to determine that an interrupt asserted by a first interrupt source is directed to a first processor on a different device and generate an IBI message identifying the interrupt source and the first processor as an interrupt target. The IBI message may include information identifying a type of the interrupt and a status associated with the interrupt. The line interface module and/or circuit 1618 may be configured to transmit the IBI message to the second device over the serial bus.

The SLIMbus wake-up module and/or circuit 1626 may be configured to determine whether the serial bus is operating in a low-power mode, and cause a change in a signaling state of the serial bus operable to wake up the serial bus when the serial bus is operating in the low-power mode, before the IBI message is transmitted to the second device over the serial bus. The clock line may be quiescent during the low-power mode. The clock line may be quiescent when the clock line is driven to, and remains in one of two available signaling states. The change in the signaling state of the serial bus may include a toggling of the data line.

The apparatus 1600 may include interrupt status registers configured to maintain a local interrupt status based on a series of IBI messages generated by the message generator. The interrupt status registers may be cleared responsive to transmission and reception of the series of IBI messages.

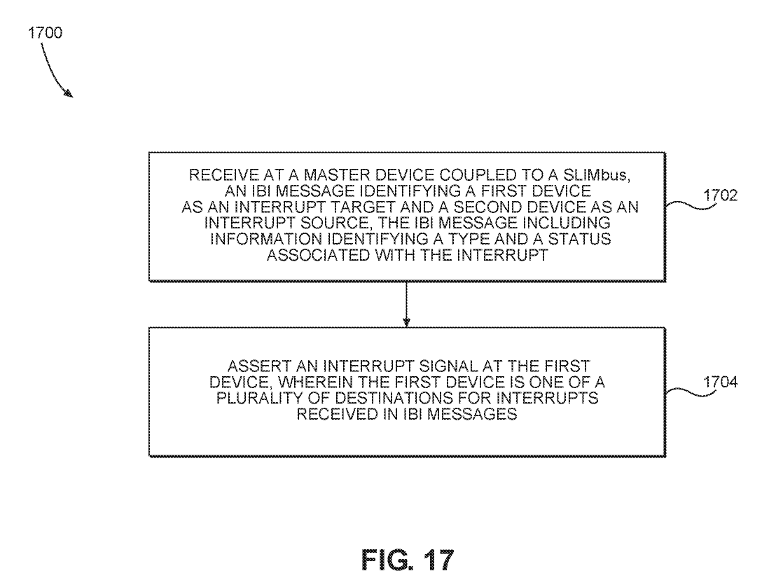

FIG. 17 is a flowchart 1700 illustrating a communications method according to certain aspects of the invention.

At step 1702, a master device coupled to a SLIMbus may receive an IBI message identifying a first device as an interrupt target and a second device as an interrupt source, the IBI message including information identifying a type and a status associated with the interrupt.

At step 1704, a slave device may assert an interrupt signal at the first device. The first device is one of a plurality of destinations for interrupts received in IBI messages.

The SLIMbus may be in a clock-stop or powered-down mode of operation prior to receipt of the IBI message. The slave device may detect that a data line of the SLIMbus has been toggled prior to receipt of the IBI message, and may wake a framer of the master device after detecting that the data line of the SLIMbus has been toggled.

The slave device may wake up a SLIMbus interface circuit of the master device after detecting that the data line of the SLIMbus has been toggled.

The slave device may actively drive a clock line of the SLIMbus after detecting that the data line of the SLIMbus has been toggled.

The slave device may store the status associated with the interrupt in a register, receive an interrupt acknowledgement from the second device, and clear the status associated with the interrupt in the register in response to the interrupt acknowledgement received from the second device.

The second device may be an AP. The first device may be a DSP. The second device may be a codec.

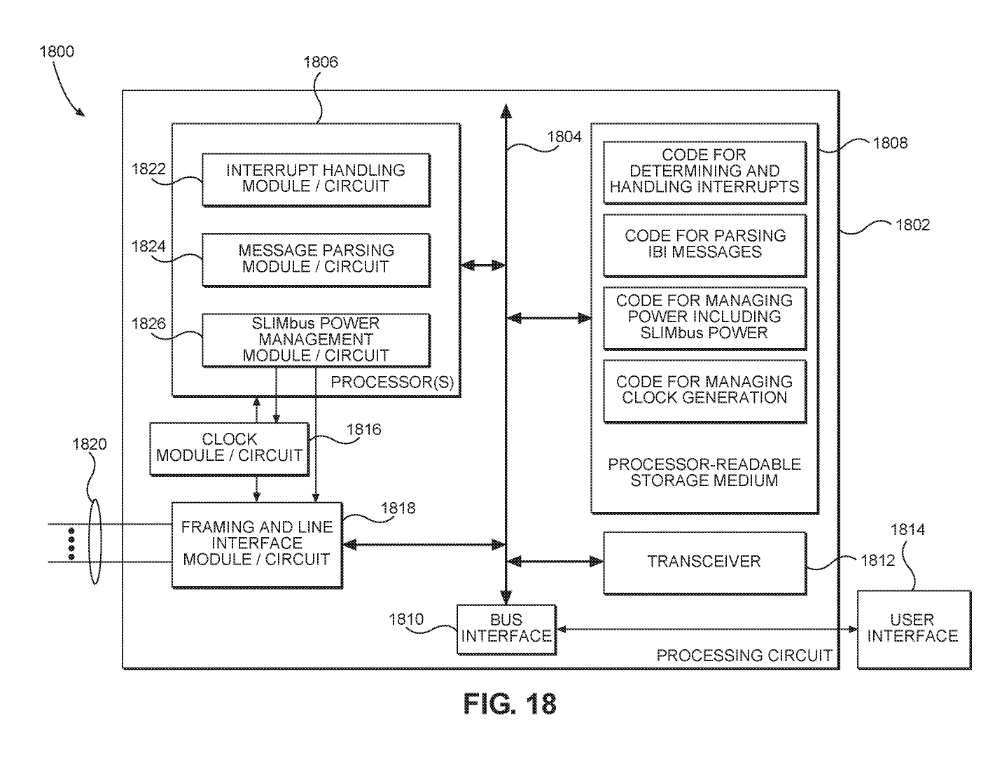

FIG. 18 is a conceptual diagram illustrating an example of a hardware implementation for an apparatus 1800 employing a processing circuit 1802. In this example, the processing circuit 1802 may be implemented with a bus architecture, represented generally by bus 1804. The bus 1804 may include any number of interconnecting buses and bridges depending on the specific application of the processing circuit 1802 and the overall design constraints. The bus 1804 links together various circuits including one or more processors, represented generally by processor 1806, and computer-readable media, represented generally by processor-readable storage medium 1808. The bus 1804 may also link various other circuits such as timing sources, timers, peripherals, voltage regulators, and power management circuits. A bus interface 1810 provides an interface between the bus 1804 and a transceiver 1812. The transceiver 1812 may include a bus interface that provides a means for communicating with various other apparatus over a transmission medium. Depending upon the nature of the apparatus, a user interface 1814 (e.g., keypad, display, speaker, microphone, joystick) may also be provided. One or more clock circuits or modules 1816 may be provided within the processing circuit 1802 or controlled by the processing circuit 1802 and/or one or more processors 1806. In one example, the clock circuits or modules 1816 may include one or more crystal oscillators, one or more phase-locked loop devices, and/or one or more configurable clock trees.

The processor 1806 is responsible for managing the bus 1804 and general processing, including the execution of software stored on the processor-readable storage medium 1808. The software, when executed by the processor 1806, causes the processing circuit 1802 to perform the various functions described above for any particular apparatus. The processor-readable storage medium 1808 may be used for storing data that is manipulated by the processor 1806 when executing software.

In one configuration, the apparatus 1800 includes a line interface module and/or circuit 1818 configured to couple the apparatus 1800 to a serial bus 1820. In the illustrated example, the serial bus 1820 may comply or be compatible with SLIMbus protocols and the line interface module and/or circuit 1818 may include a SLIMbus framer. The apparatus 1800 may include one or more interrupt sources, an interrupt handling module and/or circuit 1822, a message parsing module and/or circuit 1824, and a SLIMbus power management module and/or circuit 1826.

In one configuration, the apparatus 1800 includes the line interface module and/or circuit 1818 configured to couple the apparatus 1800 to the serial bus 1820. In the illustrated example, the serial bus 1820 may comply or be compatible with SLIMbus protocols and the line interface module and/or circuit 1818 may include a SLIMbus framer. The apparatus 1800 may include a plurality of processors 1806. The apparatus 1800 may include the message parsing module and/or circuit 1824, and an interrupt handling module and/or circuit 1822 responsive to the message parsing module and/or circuit 1824 and configured to interrupt one or more of the processors 1806. The message parsing module and/or circuit 1824 may be configured to receive the IBI message from the bus master interface, and assert an interrupt at the first device based on the content of the IBI message. The apparatus 1800 may include a power management circuit configured to detect the change in a signaling state of the serial bus, and cause the bus master interface to actively drive at least the clock line. The apparatus 1800 may include interrupt status registers configured to maintain a local interrupt status based on a series of IBI messages generated by the message generator. The interrupt status registers may be cleared responsive to transmission and reception of the series of IBI messages.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claimed, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means-plus-function unless the element is expressly recited using the phrase “means for.”

What is claimed is:

1. A communications method, comprising:
determining that an interrupt asserted within a first device coupled to a serial low-power inter-chip media bus (SLIMbus) is directed to a second device coupled to the SLIMbus;
generating an in-band interrupt (IBI) message identifying the first device as an interrupt source and the second device as an interrupt target, wherein the IBI message includes information identifying a type and a status associated with the interrupt; and
transmitting the IBI message to the second device over the SLIMbus.

2. The method of claim 1, further comprising:
determining that the SLIMbus is in a clock-stop or a powered-down mode of operation when the interrupt is determined to be asserted; and
toggling a data line of the SLIMbus prior to transmitting the IBI message to the second device.

3. The method of claim 2, further comprising:
determining that a clock signal of the SLIMbus is active after toggling the data line of the SLIMbus and prior to transmitting the IBI message to the second device.

4. The method of claim 2, further comprising:
storing the status associated with the interrupt in a register;
receiving an interrupt acknowledgement from the second device; and
clearing the status associated with the interrupt in the register in response to the interrupt acknowledgement received from the second device.

5. The method of claim 1, wherein the first device comprises a coder/decoder circuit.

6. The method of claim 1, wherein the interrupt is provided by one of a plurality of interrupt sources in the first device, and wherein the IBI message includes information distinguishing between potential sources of the interrupt.

7. The method of claim 6, wherein the second device comprises a plurality of processors, and wherein the IBI message includes information identifying one of the plurality of processors as the interrupt target.

8. The method of claim 1, wherein the second device comprises two or more processors, wherein the interrupt is provided on one interrupt request line of a plurality of interrupt request lines within the first device, and wherein the IBI message includes information identifying the one interrupt request line.

9. The method of claim 1, wherein the second device comprises an application processor (AP).

10. The method of claim 1, wherein the second device comprises a digital signal processor (DSP).

11. A communications method, comprising:
receiving at a master device coupled to a serial low-power inter-chip media bus (SLIMbus), an in-band interrupt (IBI) message identifying a first device as an interrupt target and a second device as an interrupt source, the IBI message including information identifying a type and a status associated with an interrupt; and
asserting an interrupt signal at the first device;
wherein the first device is one of a plurality of destinations for interrupts received in IBI messages.

12. The method of claim 11, wherein the SLIMbus is in a clock-stop or a powered-down mode of operation prior to receipt of the IBI message, and further comprising:
detecting that a data line of the SLIMbus has been toggled prior to receipt of the IBI message; and
waking up a framer of the master device after detecting that the data line of the SLIMbus has been toggled.

13. The method of claim 12, further comprising:
waking up a SLIMbus interface circuit of the master device after detecting that the data line of the SLIMbus has been toggled.

14. The method of claim 12, further comprising:
actively driving a clock line of the SLIMbus after detecting that the data line of the SLIMbus has been toggled.

15. The method of claim 11, further comprising:
storing the status associated with the interrupt in a register;
receiving an interrupt acknowledgement from the second device; and
clearing the status associated with the interrupt in the register in response to the interrupt acknowledgement received from the second device.

16. The method of claim 11, wherein the first device comprises an application processor (AP).

17. The method of claim 11, wherein the first device comprises a digital signal processor (DSP).

18. The method of claim 11, wherein the second device comprises a coder/decoder circuit.

19. A system comprising:
a serial bus having a clock line and at least one data line;
a first device coupled to the serial bus through a bus master interface, wherein the first device comprises a plurality of processors and a message parser; and
a second device coupled to the serial bus through a bus slave interface, wherein the second device includes an interrupt source and a message generator;
wherein the message generator is configured to:
determine that an interrupt asserted by a first interrupt source is directed to a first processor on the first device;
generate an in-band interrupt (IBI) message identifying the interrupt source and the first processor as an interrupt target, wherein the IBI message includes information identifying a type of the interrupt and a status associated with the interrupt;
wherein the bus slave interface is configured to:
transmit the IBI message to the second device over the serial bus; and
wherein the message parser is configured to:
receive the IBI message from the bus master interface; and
assert the interrupt at the first device based on a content of the IBI message.

20. The system of claim 19, wherein the serial bus is operated in accordance with a time-division transmission protocol.

21. The system of claim 19, wherein the second device comprises a circuit configured to:
determine whether the serial bus is operating in a low-power mode; and
cause a change in a signaling state of the serial bus operable to wake up the serial bus when the serial bus is operating in the low-power mode, before the IBI message is transmitted to the second device over the serial bus.

22. The system of claim 21, wherein the clock line is quiescent during the low-power mode.

23. The system of claim 21, wherein the change in the signaling state of the serial bus comprises a toggling of the at least one data line.

24. The system of claim 21, wherein the first device comprises a power management circuit configured to:
detect the change in the signaling state of the serial bus; and
cause the bus master interface to actively drive at least the clock line.

25. The system of claim 19, wherein the serial bus comprises a serial low-power inter-chip media bus (SLIMbus).

26. The system of claim 19, wherein the first device and the second device each include interrupt status registers configured to maintain a local interrupt status based on a series of IBI messages generated by the message generator.

27. The system of claim 26, wherein the interrupt status registers of the first device and the second device are cleared responsive to transmission and reception of the series of IBI messages.

28. The system of claim 19, wherein the interrupt is provided by one of a plurality of interrupt sources within the second device, and wherein the IBI message includes information distinguishing between potential sources of the interrupt.

29. The system of claim 28, wherein the IBI message includes information identifying one of the plurality of processors as the interrupt target.

30. The system of claim 19, wherein the interrupt is provided on one interrupt request line of a plurality of interrupt request lines within the second device, and wherein the IBI message includes information identifying the one interrupt request line.
